(19) United States
(12) Patent Application Publication
(10) Pub. No.: US 2024/0253586 A1
(43) Pub. Date: Aug. 1, 2024

(54) STRUCTURAL PART FOR A TRUCK, COMPRISING A BEAM MADE OF FIBER-REINFORCED PLASTIC

(71) Applicant: Volvo Truck Corporation, Göteborg (SE)

(72) Inventors: Giri SANKAR, Saint-Priest (FR); Samarth Dattatraya HAREL, Bangalore (IN)

(21) Appl. No.: 18/413,206

(22) Filed: Jan. 16, 2024

(30) Foreign Application Priority Data
Jan. 27, 2023 (EP) 23153749.9

(51) Int. Cl. B60R 19/52; B29C 45/00; B29C 45/27; B29K 77/00; B29K 105/12; B29K 309/08; B29L 31/30; B62D 29/04

(52) U.S. Cl. CPC B60R 19/52; B29C 45/0005; B29C 45/2708; B62D 29/043; B29K 2077/00; B29K 2105/12; B29K 2309/08; B29L 2031/3005

(57) ABSTRACT

A structural part for a truck, comprising a beam made of fiber-reinforced plastic, the beam having a I-shaped cross-section, the beam comprising a web extending from a first flange to a second flange, in which a cross-section of the web comprises a first portion with a first thickness; a second portion with a second thickness, the second thickness being larger than the first thickness; and a third portion with a third thickness, the third thickness being smaller than the second thickness, in which the second portion is located between the first portion and the third portion.

### PRIORITY APPLICATIONS

This present application claims priority to European Patent Application No. 23153749.9, filed on Jan. 27, 2023, and entitled “STRUCTURAL PART FOR A TRUCK, COMPRISING A BEAM MADE OF FIBER-REINFORCED PLASTIC,” which is incorporated herein by reference in its entirety.

### TECHNICAL FIELD

This disclosure relates to a structural part for equipping an industrial vehicle, in particular a truck.

### BACKGROUND ART

Some structural parts used on trucks may be beam shaped. For example, the grille of the truck may comprise a cover with an aesthetic role fixed to a beam with a load-bearing function. The beam of the grille is often made of steel, which provides high mechanical properties and moderate cost.

In order to decrease the overall weight of the vehicles, fiber-reinforced plastic materials have often been used for the manufacture of vehicle parts. For example, glass fiber reinforced polyamide have been used for a wide range of applications, in which a mix of molten plastic and reinforcing fibers is pressurized and injected into a mold providing the target shape of the part. Nevertheless, this material has proven to be difficult to process to fabricate structural components like beams. In particular, these injected plastic parts often suffer from various issues, like short fill or warpage. These issues often result in a high scrap rate which is not acceptable.

There is therefore a need for providing a solution to manufacture structural parts like beams from fiber-reinforced plastic materials.

### SUMMARY

To this end, it is proposed a structural part for a truck, comprising: a beam made of fiber-reinforced plastic, the beam having a I-shaped cross-section, the beam comprising a web extending from a first flange to a second flange, in which a cross-section of the web comprises:
a first portion with a first thickness,
a second portion with a second thickness, the second thickness being larger than the first thickness, and
a third portion with a third thickness, the third thickness being smaller than the second thickness, and in which the second portion is located between the first portion and the third portion.

Compared with conventional I-shaped beams in which the thickness of the web is constant except in the region where the web joins the flanges, the proposed structural part comprises a web in which a portion is enlarged compared to the neighboring portions. This enlarged portion can act as a flow leader for the molten material when the structural part is molded. The flow of molten plastic is easier, and issues usually associated with high viscosity plastic material, like short fills, can be avoided. Structural parts made of plastic material reinforced by fibers can be manufactured.

The following features can optionally be implemented, separately or in combination one with the others:

According to an aspect of the structural part, a cross-section of the web extends along a main extension axis transverse to the first flange and to the second flange. A cross-section of the first flange comprises a first portion and a second portion extending symmetrically relatively to the main extension axis of the web, and
each portion of the first flange has a thickness decreasing continuously from the main extension axis of the web to a free end of each portion of the first flange.

In an embodiment of the structural part:
the first portion of the first flange comprises a first side orientated away from the web and a second side orientated towards the web,
the second portion of the first flange comprises a first side orientated away from the web and a second side orientated towards the web, and
the first side of the first portion of the first flange meets with the first side of the second portion of the first flange at an angle comprised between 166° and 177°.

The decreasing thickness and relative orientation of the sides of the first portion of the flange provides a draft angle for the mold opening during the injection process for manufacturing the beam, the parting line between the elements of the mold corresponding to the main extension axis of a cross section of the web of the beam.

Similarly, the second side of the first portion of the first flange meets with the second side of the second portion of the first flange at an angle comprised between 166° and 177°.

A cross-section of the second flange comprises a first portion and a second portion extending symmetrically relatively to the main extension axis of the web, and each portion has a thickness decreasing continuously from the main extension axis of the web to a free end of each portion of the second flange.

The first portion of the second flange comprises a first side orientated away from the web and a second side orientated towards the web.

The second portion of the second flange comprises a first side orientated away from the web and a second side orientated towards the web.

In an embodiment, the first side of the first portion of the second flange meets with the first side of the second portion of the second flange at an angle comprised between 166° and 177°.

Similarly, the second side of the first portion of the second flange meets with the second side of the second portion of the second flange at an angle comprised between 166° and 177°.

This range of angle provides a draft angle suitable for an easy opening of the mold when the beam is injected.

In an example of implementation, the thickness of the first portion of the web is identical to the thickness of the third portion of the web.

The web comprises two portions of constant thickness separated by an enlarged portion, the enlarged portion having a larger thickness than the two portions of constant thickness.

In an embodiment of the structural part, the web extends along a main extension axis transverse to the first flange and to the second flange, and the main extension axis of the web is an axis of symmetry of the cross section of the beam.

According to an embodiment, an axis passing through a centroid of the second portion and perpendicular to the main extension axis of a cross-section of the web is an axis of symmetry of the cross section of the beam.

The beam has the same mechanical properties when it is used in a given orientation or turned by 180° relatively to this given orientation.

The main axis of the web is perpendicular to the axis of the first flange and to the axis of the second flange.

According to an embodiment, the second portion of the web has a constant thickness.

In an embodiment, starting from the first portion of the web and moving in direction of the third portion of the web, the second portion of the web comprises a first zone of continuously increasing thickness followed by a second zone of continuously decreasing thickness.

In an embodiment, starting from the first portion of the web and moving in direction of the third portion of the web, the second portion of the web comprises successively a first concave section, a convex section and a second concave section.

This succession of curved portions provides a high concentration of reinforcing fibers in areas subjected to high stresses when mechanical loads are applied to the beam.

In an example of implementation of the structural part, the second portion of the web is closer to the first flange than to the second flange.

In a variant, the second portion of the web is closer to the second flange than to the first flange.

A ratio of the cross-section area of the second portion of the web over the total cross-section area of the web is comprised between 0.25 and 0.5.

A ratio of the extension length of the second portion of the web over the total extension length of the web is comprised between 0.2 and 0.35.

A ratio of the thickness of the second portion of the web over the thickness of the first portion of the web is comprised between 1.2 and 2.5.

The cross section of the beam is constant along the length of the beam.

The material of the beam comprises a mix of reinforcing glass fibers with thermoplastic material.

In an embodiment of the structural part, the material of the beam comprises a mix of reinforcing glass fibers with polyamide plastic material.

The polyamide material is for example PA6. (for “polycaprolactan”)

This material combines good mechanical properties and reasonable cost.

The reinforcing fibers are for example glass fibers.

A weight ratio of reinforcing glass fibers is comprised between 15% and 40%.

This range of fibers concentration provides high mechanical properties.

The disclosure also refers to a method for manufacturing a structural part as described earlier, comprising the steps:
(i) supplying a two-part mold, comprising a set of injection points offset along a main extension axis of the beam,
the injection points facing a first flange of the beam,
(ii) injecting a mix of molten plastic and reinforcing fibers so as to form the beam.

The molten plastic is injected in a direction parallel to the extension axis of a cross-section of the web of the beam.

This injection direction together with the shape of the enlarged portion of the web makes the manufacturing of structural parts possible.

The disclosure relates as well to a truck grille comprising:
a structural part as described earlier,
a cover attached to the structural part.

In an embodiment, the truck grille comprises:
two support arms extending transversely to the beam,
and the support arms are configured to be pivotably fixed to a cabin of a truck.

The support arms are fixed to the beam.

The support arms are fixed to opposite axial ends of the beam.

The disclosure also refers to a truck comprising a truck grille as described above, in which the truck grille can be pivoted between:
a first position in which the truck grille is flush with a front surface of a truck cabin,
a second position in which the truck grille protrudes out of the front surface of the truck cabin, so that the grille forms a step member for climbing along the cabin of the truck.

The grille is rotated by 90° between the first position and the second position.

The flanges of the beam are horizontal when the grille is in the first position.

The web of the beam is horizontal when the grille is in the second position.

### BRIEF DESCRIPTION OF DRAWINGS

Other features, details and advantages will be shown in the following detailed description and in the figures, in which:

FIG. 1 is a schematic side view of a truck equipped with a structural part according to the disclosure,

FIG. 2 is a perspective view of a truck equipped with a structural part according to the disclosure,

FIG. 3 is a schematic side view of a structural part according to a first embodiment,

FIG. 4 is a perspective view of a structural part according to a second embodiment,

FIG. 5 is a side view of the structural part of FIG. 4,

FIGS. 6A-6B are a schematic side view of a structural part according to the second embodiment,

FIG. 7 is another perspective view of a structural part according to a second embodiment,

FIGS. 8A-8C are a schematic view illustrating steps of the manufacturing method of a structural part according to the disclosure, and

FIGS. 9A-9B are a schematic view illustrating a variant of the method of FIGS. 8A-8C.

### DESCRIPTION OF EMBODIMENTS

In order to make the figures easier to read, the various elements are not necessarily represented to scale. In these figures, identical elements receive the same reference number. Certain elements or parameters can be indexed, that is to say designated for example by ‘first element’ or second element, or first parameter and second parameter, etc. The purpose of this indexing is to differentiate elements or parameters that are similar, but not identical. This indexing does not imply a priority of one element, or one parameter over another, and their names can be interchanged. When it is mentioned that a subsystem comprises a given element, the presence of other elements in this subsystem is not excluded.

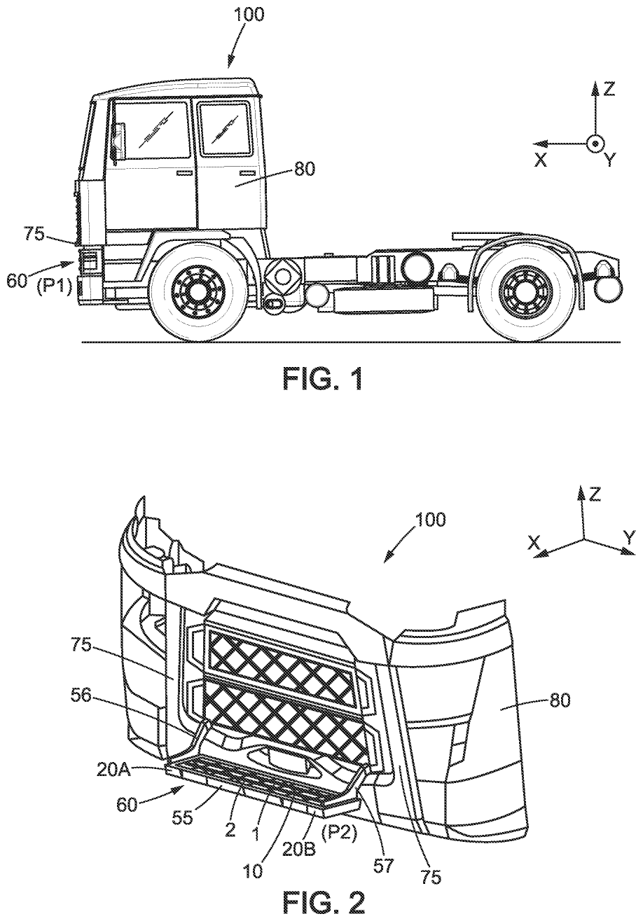

FIG. 1 illustrates a truck 100. The truck 100 is here a cab-over truck, but the proposed solution is applicable to any kind of truck. It can also be applied to other large transport vehicles like buses.

The truck 100 comprises a cabin 80 ending by a front surface 75. The front surface 75 comprises a grille 60.

The truck 100 comprises a truck grille 60 which can be pivoted between:
a first position P1 in which the truck grille 60 is flush with a front surface 75 of a truck cabin 80,
a second position P2 in which the truck grille 60 protrudes out of the front surface 75 of the truck cabin 80, so that the grille 60 forms a step member for climbing along the cabin 80 of the truck 100.

In FIG. 1, the grille 60 is flush with the front surface 75 of the cabin 80. In FIG. 2, the grille 60 has been rotated and reached the second position P2. In this second position P2, the grille 60 can be used as a step member. A user can step over the grille 60 once it is in the second position P2, for example for cleaning the windshield or the upper part of the cabin 80.

The grille 60 is for example rotated by 90° between the first position P1 and the second position P2.

The truck grille 60 comprises:
a structural part 50 that will be detailed below,
a cover 55 attached to the structural part 50.

The structural part 50 comprises a beam 10. By definition, a structural part is a part with load bearing capacities of at least 1000 N.

More precisely, the truck grille 60 comprises two support arms 56, 57 extending transversely to the beam 10, and the support arms 56, 57 are configured to be pivotably fixed to the cabin 80 of the truck 100.

The support arms 56, 57 are fixed to the beam 10. The support arms 56, 57 are here fixed to opposite axial ends 20A, 20B of the beam 10, as indicated in FIG. 2. The fasteners of the support arms 56, 57 on the beam 10 are not represented in FIG. 2.

The cover 55 has an aesthetic role, and no structural role. The cover 55 can for example by clipped over the structural part 50.

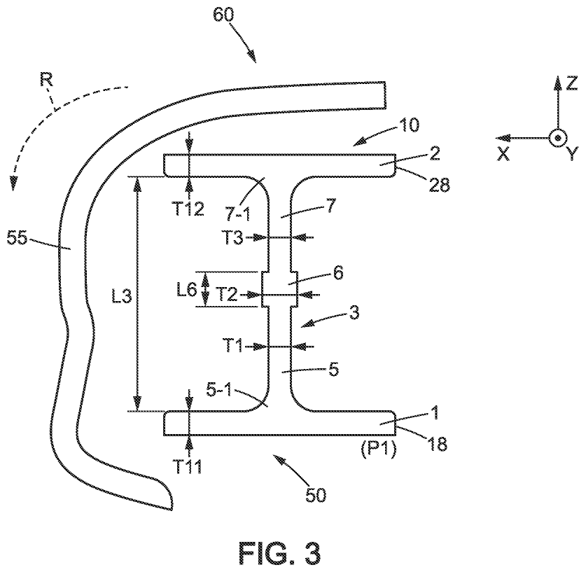

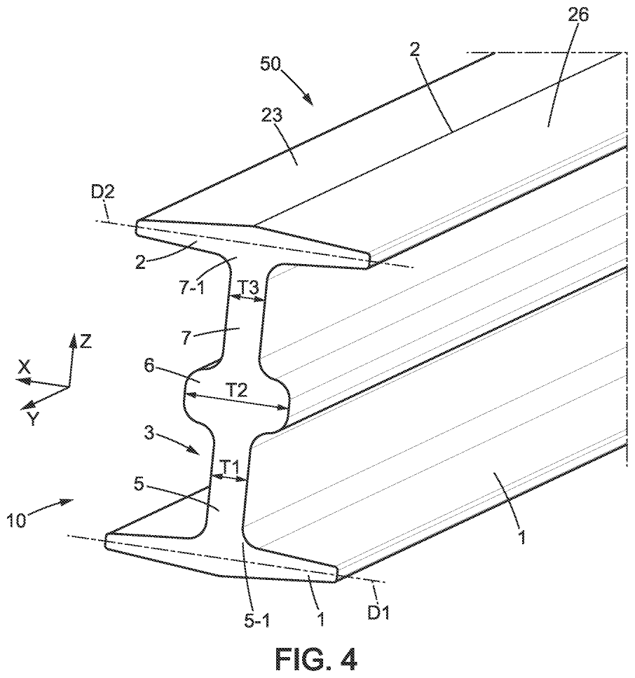

FIG. 3 illustrates the truck grille 60 in the first position P1. A cross-section of the beam 10 has an I-shape. The cross-section of the beam 10 comprises two flanges 1, 2 connected by a web 3.

The flanges 1, 2 of the beam 10 are horizontal when the grille 60 is in the first position P1. The web 3 of the beam 10 is horizontal when the grille 60 is in the second position P2. The flanges 1, 2 are vertical when the grille 60 is in the second position P2, as it is the case in FIG. 2.

A user stepping over the grille 60 contacts the free ends 18, 28 of the flanges 1, 2 when he steps on the step member formed by the grille 60.

In FIG. 3, the support arms have not been represented, for better visibility of the beam 10. The arrow designated by the sign R indicates the direction in which the grille 60 can pivot during the transition from the first position P1 to the second position P2.

The proposed structural part 50 for a truck 100 comprises: a beam 10 made of fiber-reinforced plastic, the beam 10 having a I-shaped cross-section, the beam 10 comprising a web 3 extending from a first flange 1 to a second flange 2.

A cross-section of the web 3 comprises:
a first portion 5 with a first thickness T1,
a second portion 6 with a second thickness T2, the second thickness T2 being larger than the first thickness T1,
a third portion 7 with a third thickness T3, the third thickness T3 being smaller than the second thickness T2,
and second portion 6 is located between the first portion 5 and the third portion 7.

Compared with conventional I-shaped beams in which the thickness of the web 3 is constant except in the region where the web 3 joins the first 1 and second flange 2, the proposed structural part 50 comprises a web 3 in which a portion is enlarged compared to its neighboring portions. This enlarged portion can act as a flow leader for the molten material when the structural part 50 is molded. The flow of molten plastic is easier, and issues usually associated with high viscosity plastic material, like short fills, can be avoided. Thanks to this geometry, structural parts made of plastic material reinforced by fibers can be manufactured with high level of quality and low scrap rates.

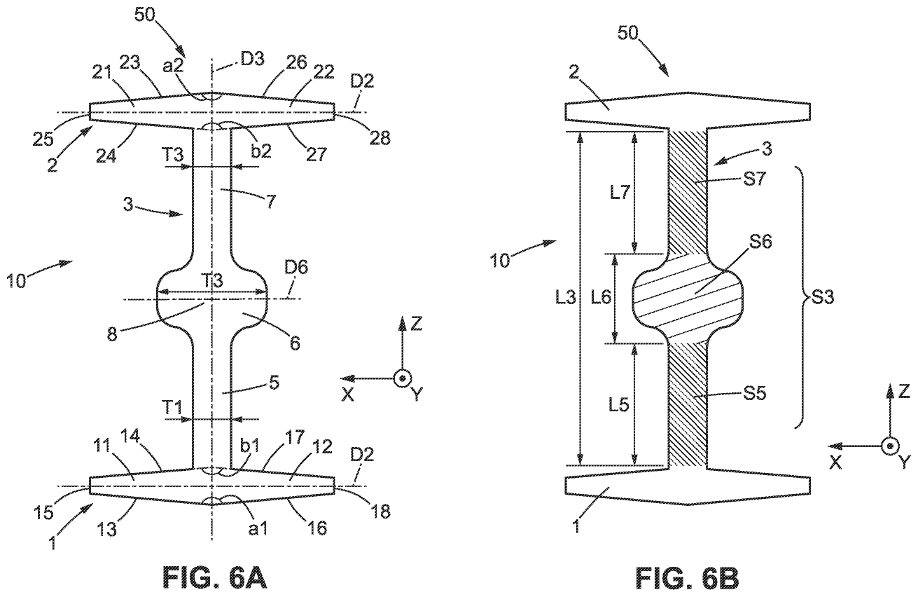

As illustrated in FIG. 6A, a cross-section of the web 3 extends along a main extension axis D3 transverse to the first flange 1 and to the second flange 2. A cross-section of the first flange 1 comprises a first portion 11 and a second portion 12 extending symmetrically relatively to the main extension axis D3 of the web 3, and each portion 11, 12 of the first flange 1 has a thickness decreasing continuously from the main extension axis D3 of the web 3 to a free end 15, 18 of each portion 11, 12 of the first flange 1.

A main extension axis for a given shape is the axis corresponding to the longest dimension of this shape. For example, for a rectangular shape the extension axis is parallel to the long sides of the rectangle.

The web 3 extends along a main extension axis D3. The thickness of the web 3 is the dimension measured transversely to the main extension axis D3 of the web 3. Similarly, the first thickness T1, second thickness T2, and third thickness T3 are all measured transversely to the main extension axis D3 of the web 3.

The second portion 6 is located between the first portion 5 and the third portion 7 along the main extension axis D3. In other words, the first portion 5, the second portion 6 and the third portion 7 are disposed successively in this order along the main extension axis D3 of the web 3.

In an embodiment of the structural part 20, illustrated in FIG. 6A:
the first portion 11 of the first flange 1 comprises a first side 13 orientated away from the web 3 and a second side 14 orientated towards the web 3,
the second portion 12 of the first flange 1 comprises a first side 16 orientated away from the web 3 and a second side 17 orientated towards the web 3, and
the first side 13 of the first portion 11 of the first flange 1 meets with the first side 16 of the second portion 12 of the first flange 1 at an angle a1 comprised between 166° and 177°.

Similarly, the second side 14 of the first portion 11 of the first flange 1 meets with the second side 17 of the second portion 12 of the first flange 1 at an angle b1 comprised between 166° and 177°.

The decreasing thickness and the relative orientation of the sides 13, 14 of the first portion 11 of the first flange 11 provides a draft angle for a mold opening during the injection process for manufacturing the beam 10. The parting line between the elements of the mold corresponds in this case to the main extension axis D3 of a cross section of the web 3 of the beam 10.

In the same way, a cross-section of the second flange 2 comprises a first portion 21 and a second portion 22 extending symmetrically relatively to the main extension axis D3 of the web 3, and in which each portion 21, 22 has a thickness decreasing continuously from the main extension axis D3 of the web 3 to a free end 25, 28 of each portion 21, 22 of the second flange 2.

The first portion 21 of the second flange 2 comprises a first side 23 orientated away from the web 3 and a second side 24 orientated towards the web 3.

The second portion 22 of the second flange 2 comprises a first side 26 orientated away from the web 3 and a second side 27 orientated towards the web 3.

The first side 23 of the first portion 21 of the second flange 2 meets with the first side 26 of the second portion 22 of the second flange 2 at an angle a2 comprised between 166° and 177°.

Similarly, the second side 24 of the first portion 21 of the second flange 2 meets with the second side 27 of the second portion 22 of the second flange 2 at an angle b2 comprised between 166° and 177°.

This range of angle provides a draft angle suitable for an easy opening of the mold when the beam 10 is injected.

In the illustrated examples, the thickness T1 of the first portion 5 of the web 3 is identical to the thickness T3 of the third portion 7 of the web 3.

The web 3 comprises two portions 5, 7 of constant thickness separated by an enlarged portion 6, the enlarged portion 6 having a larger thickness than the two portions 5, 7 of constant thickness.

In the illustrated examples, the web 3 extends along a main extension axis D3 transverse to the first flange 1 and to the second flange 2, and the main extension axis D3 of the web 3 is an axis of symmetry of the cross section of the beam 10.

A I-shaped cross section comprises a first flange 1 with an elongated shape and a second flange 2 with an elongated shape, the two flanges 1, 2 extending parallelly to each other, the two flanges 1, 2 being connected by a web 3 extending transversely to the flanges 1, 2, the cross section being symmetrical relatively to the extension axis D3 of the web 3.

A cross-section of the first flange 1 extends along a main axis D1. The thickness of the first flange 1 is the dimension measured transversely to the main extension axis D1 of the cross-section of the first flange 1. Similarly, a cross-section of the second flange 2 extends along a main axis D2. The thickness of the second flange 2 is the dimension measured transversely to the main extension axis D2 of the cross-section of the second flange 2. The main axis D1 of the first flange 1 is parallel to the main axis D2 of the second flange 2. The main axis D3 of the web 3 is perpendicular to the axis D1 of the first flange 1 and to the axis D2 of the second flange 2.

The web 3 connects to the first flange 1 by a first flared portion 5-1. The thickness of the first flared portion 5-1 progressively increases between the first portion 5 of the web 3 and the first flange 1. Similarly, the web 3 connects to the second flange 2 by a second flared portion 7-1, whose thickness progressively increases between the second portion 7 of the web 3 and the second flange 2.

The first and second flared portions 5, 7 provide areas of high concentration of reinforcing fibers in areas subjected to large stresses when mechanical loads are applied.

According to the illustrated embodiments, an axis D6 passing through a centroid 8 of the second portion 6 and perpendicular to the main extension axis D3 of a cross-section of the web 3 is an axis of symmetry of the cross section of the beam 10.

The beam 10 has thus the same mechanical properties when it used in a given orientation, or turned by 180° relatively to this given orientation.

FIG. 3 represents an embodiment in which the second portion 6 of the web 3 has a constant thickness T2. The second portion 6 of the web 3 has thus a rectangular cross section.

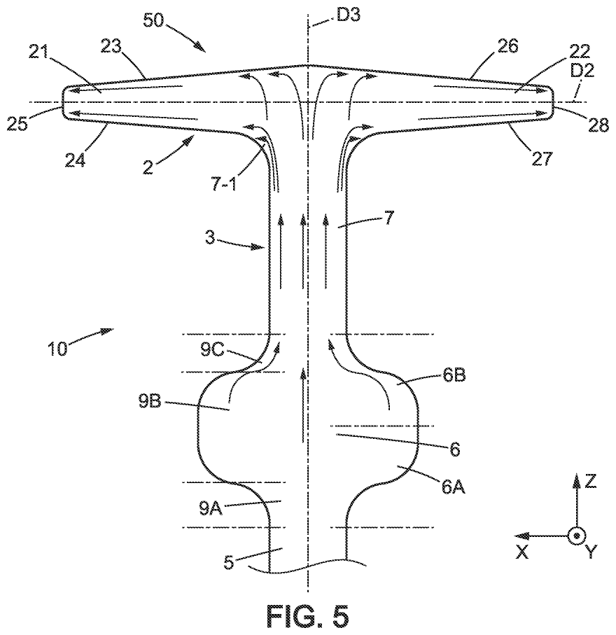

In another embodiment, starting from the first portion 5 of the web 3 and moving in direction of the third portion 7 of the web 3, the second portion 6 of the web 3 comprises a first zone 6A of continuously increasing thickness followed by a second zone 6B of continuously decreasing thickness. This first zone 6A and second zone 6B are more particularly illustrated in FIG. 5.

A curve of the thickness of the second portion 6 of the web 3 versus the distance from the first flange 1 is continuously increasing in a first stage corresponding to the first zone 6A, then continuously decreasing in a second stage corresponding to the second zone 6B.

The first zone 6A of the second portion 6 of the web 3 separates the first portion 5 of the web 3 from the second zone 6B of the second portion 6 of the web 3. The second zone 6B of the second portion 6 of the web 3 separates the first zone 6A of the second portion 6 of the web 3 from the third portion 7 of the web 3. The second portion 6 has the shape of a bulge.

Starting from the first portion 5 of the web 3 and moving in direction of the third portion 7 of the web 3, the second portion 6 of the web 3 comprises successively a first concave section 9A, a convex section 9B and a second concave section 9C.

By definition, any segment joining two points from the periphery of a convex section is included in this convex section. Any segment joining two points of the periphery of a concave section is outside of this concave section.

This succession of curved portions provides a high concentration of reinforcing fibers in areas subjected to high stresses when mechanical loads are applied to the beam.

On the illustrated embodiments, the distance between the second portion 6 of the web 3 and the first flange 1 is identical to the distance between the second portion 6 of the web 3 and the second flange 2.

According to a non-represented embodiment of the structural part 50, the second portion 6 of the web 3 is closer to the first flange 1 than to the second flange 2. In another non-represented variant, the second portion 6 of the web 3 is closer to the second flange 2 than to the first flange 1.

A ratio of the cross-section area S6 of the second portion 6 of the web 3 over the total cross-section area S3 of the web 3 is comprised between 0.25 and 0.5.

As illustrated in FIG. 6B, the total cross-section area S3 of the web 3 is the sum of the cross-section area S5 of the first portion 5, of the cross-section area S6 of the second portion 6, and of the cross-section S7 of the third portion 7 of the web 3. A ratio of the extension length L6 of the second portion 6 of the web 3 over the total extension length L3 of the web 3 is comprised between 0.2 and 0.35.

The total extension length L3 of the web 3 is the sum of the extension length L5 of the first portion 5, of the extension length L6 of the second portion 6, and of the extension length L7 of the third portion 7 of the web 3.

The extension length L6 of the second portion 6 is measured along the main extension axis D3 of the web 3. In the same way, the extension length L5 of the first portion 5 and the extension length L7 of the third portion 7 of the web 3 are measured along the main extension axis D3 of the web 3. The total extension length L3 of the web 3 may be referred to as the depth of the web 3.

A ratio of the thickness T2 of the second portion 6 of the web 3 over the thickness T1 of the first portion 5 of the web 3 is comprised between 1.2 and 2.5.

When the second portion has a bulged shape and its thickness is not constant, the thickness T2 is defined as the maximum thickness of the second portion, i.e., the thickness of the thickest location.

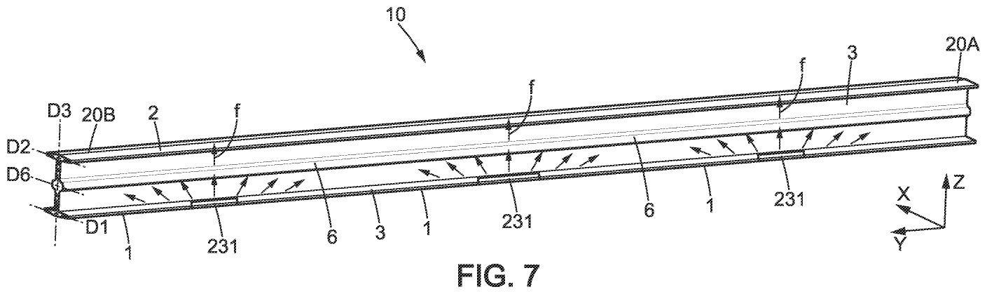

FIG. 7 represents a perspective view of the beam 10. The cross section of the beam 10 is constant along the length of the beam 10.

In FIG. 7, the vertical axis Z coincides with the axis D3 of a cross-section of the web 3. The longitudinal axis X coincides with the axis D1, D2 of a cross-section of the first flange 1 and second flange 2. The transversal axis Y is the main extension axis of the beam 10. The axis X, Y, Z are perpendicular to each other two by two.

The material of the beam 10 comprises a mix of reinforcing glass fibers with thermoplastic material.

For example, the material of the beam 10 comprises a mix of reinforcing glass fibers with polyamide plastic material. The polyamide material is for example PA6. (for “polycaprolactam”). This material combines good mechanical properties with reasonable cost.

The reinforcing fibers are for example glass fibers. A weight ratio of reinforcing glass fibers is comprised between 15% and 40%. This range of fibers concentration provides high mechanical properties.

A method for manufacturing a structural part 50 as described earlier will now be described. The method comprises the steps:
(i) supplying a two-part mold 210, 220, comprising a set of injection points 230 offset along a main extension axis D1 of the beam 10,
the injection points 230 facing a first flange 1 of the beam 10,
(ii) injecting a mix of molten plastic and reinforcing fibers so as to form the beam 10.

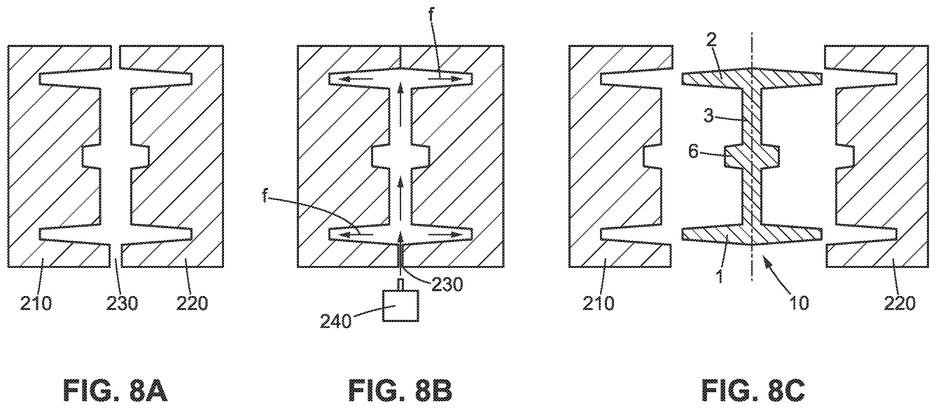

In FIG. 8A, the two parts 210, 220 of the mold are separated from each other. In FIG. 8B, the two parts 20, 220 of the mold are joined and clamped together, defining a cavity in which a mix of molten plastic and reinforcing fibers can be injected by an injection device 240. In FIG. 8C, the molten mix has been put in shape and has cooled down. The mold is opened so that the injected beam 10 can be retrieved. The process can then be iterated to generate another part.

In FIGS. 7-9B, the arrows f schematically illustrate the flow of molten plastic and fibers. In the embodiment illustrated in FIGS. 8A-8C, the molten plastic is injected in a direction parallel to the extension axis D3 of a cross-section of the web 3 of the beam 10. In FIG. 7, the signs 231 correspond to areas of the beam that are facing injection points. A different number of injection points may be used.

The molten plastic, containing reinforcement fibers, flows into the mold and fills the cavity of the mold. The plastic flows from an injection point 230 located on a first flange 1, and progresses towards the enlarged area 6, then towards the second flange 2.

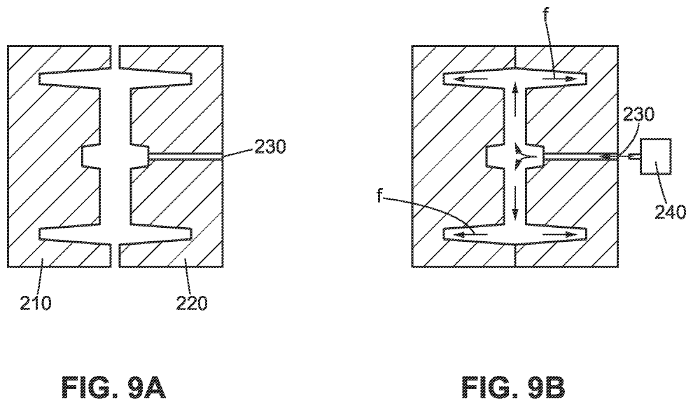

The injection point can also be disposed differently respectively to the mold. On the embodiment illustrated in FIGS. 9A-9B, the injection point is disposed on a side of the second part 220 of the mold. The mix of molten plastic and reinforcement fibers is injected in a direction transverse of the extension axis D3 of a cross-section of the web 3 of the beam 10. With this injection set-up, the filling of the mold may be easier, particularly in the direction transverse to D3. The end portions 15, 18 of the first flange 1 and the end portions 25, 28 of the second flange 2 may receive a more uniform flow of molten material. The exact number of injection points and their exact location are adapted to the dimensions of the beam to be obtained and to the selected material.

The enlarged portion 6 of the web 3 makes the flow of molten plastic easier, and the mold cavities can be fully filled. Defaults usually associated with difficulties in properly filling the mold, such as short fill or flows lines, are avoided. The selected injection direction, together with the shape of the enlarged portion 6 of the web 3 makes the manufacturing of plastic structural parts possible. The parts obtained with this method may be cheaper and lighter than the counterparts in metal.

1. A structural part for a truck, comprising:
a beam made of fiber-reinforced plastic, the beam having a I-shaped cross-section, the beam comprising a web extending from a first flange to a second flange;
wherein a cross-section of the web comprises:
a first portion with a first thickness;
a second portion with a second thickness, the second thickness being larger than the first thickness; and
a third portion with a third thickness, the third thickness being smaller than the second thickness;
wherein the second portion is located between the first portion and the third portion.

2. The structural part of claim 1, wherein a cross-section of the web extends along a main extension axis transverse to the first flange and to the second flange, wherein a cross-section of the first flange comprises a first portion and a second portion extending symmetrically relatively to the main extension axis of the web; and
wherein each portion of the first flange has a thickness decreasing continuously from the main extension axis of the web to a free end of each portion of the first flange.

3. The structural part of claim 2, wherein:
the first portion of the first flange comprises a first side orientated away from the web and a second side orientated towards the web;
the second portion of the first flange comprises a first side orientated away from the web and a second side orientated towards the web; and
the first side of the first portion of the first flange meets with the first side of the second portion of the first flange at an angle comprised between 166° and 176°.

4. The structural part of claim 1, wherein the thickness of the first portion of the web is identical to the thickness of the third portion of the web.

5. The structural part of claim 1, wherein the second portion of the web has a constant thickness.

6. The structural part of claim 1, wherein, starting from the first portion of the web and moving in direction of the third portion of the web, the second portion of the web comprises a first zone of continuously increasing thickness followed by a second zone of continuously decreasing thickness.

7. The structural part of claim 1, wherein, starting from the first portion of the web and moving in direction of the third portion of the web, the second portion of the web comprises successively a first concave section, a convex section, and a second concave section.

8. The structural part of claim 1, wherein the second portion of the web is closer to the first flange than to the second flange.

9. The structural part of claim 1, wherein a ratio of the cross-section area of the second portion of the web over the total cross-section area of the web is comprised between 0.25 and 0.5.

10. The structural part of claim 1, wherein a ratio of the extension length of the second portion 20 of the web over the total extension length of the web is comprised between 0.2 and 0.35.

11. The structural part of claim 1, wherein a ratio of the thickness of the second portion of the web over the thickness of the first portion of the web is comprised between 1.2 and 2.5.

12. The structural part of claim 1, wherein the material of the beam comprises a mix of reinforcing glass fibers with polyamide plastic material.

13. A method for manufacturing the structural part of claim 1, further comprising:
supplying a two-part mold comprising a set of injection points offset along a main extension axis of the beam, the injection points facing a first flange of the beam; and
injecting a mix of molten plastic and reinforcing fibers so as to form the beam.

14. A truck grille comprising:
the structural part of claim 1;
a cover attached to the structural part; and
two support arms extending transversely to the beam;
wherein the support arms are configured to be pivotably fixed to a cabin of a truck.

15. A truck comprising the truck grille of claim 14, wherein the truck grille can be pivoted between:
a first position, wherein the truck grille is flush with a front surface of a truck cabin; and
a second position, wherein the truck grille protrudes out of the front surface of the truck cabin, so that the grille forms a step member for climbing along the cabin of the truck.
